(19) United States
(12) Patent Application Publication
(10) Pub. No.: US 2024/0376777 A1
(43) Pub. Date: Nov. 14, 2024

(54) LADDER

(71) Applicant: Zarges GmbH, Weilheim (DE)

(72) Inventors: Andreas Eierschmalz, Garmisch-Partenkirchen (DE); Manfred Matthäus Geier, Puchheim (DE)

(21) Appl. No.: 18/221,844

(22) Filed: Jul. 13, 2023

(30) Foreign Application Priority Data
May 13, 2022 (DE) 20 2022 102 665.3
May 9, 2023 (EP) 23172371.9

(51) Int. Cl. E06C 7/02; E06C 1/32

(52) U.S. Cl. CPC E06C 7/02; E06C 1/32

(57) ABSTRACT

A ladder including a step leg and a support leg connected to the step leg with a joint. The joint is adjustable and the ladder latches automatically with the joint in the angular positions at 0°, between 25° and 45°, between 100° and 120° and at 180°.

### CROSS REFERENCE TO RELATED APPLICATIONS

This application claims priority to German utility model DE 20 2022 102 665.3, filed May 13, 2022, and to European patent application EP 23172371.9, filed May 9, 2023, the entire content of both documents is incorporated herein by reference.

### TECHNICAL FIELD

The disclosure relates to a ladder.

### BACKGROUND

Ladders with two ladder legs have long been known as stepladders. The two ladder legs are connected to each other by a joint and can be pivoted relative to each other. The pivoting angle is suitably limited, e.g., at 45 degrees, and (at least) one of the ladder legs has treads, usually in the form of steps, so that it forms a step leg, while the other forms a support leg.

Such a ladder is in contrast to a leaning ladder itself. Compared to a stepladder, a leaning ladder has the advantage that almost twice the climbing height is possible with the same amount of material.

In order to combine the advantages of both ladder types, so-called multi-purpose ladders have been developed, which also have 2 ladder legs connected with a ladder joint, but with this joint the pivoting angle is limited at about 180 degrees. The joint also allows both ladder legs to be fixed or latched together at a plurality of pivoting angles. In such ladders, both ladder legs generally have treads, often partly steps and partly rungs.

Extendable or telescopic ladders are also known in which one ladder part can slide relative to another ladder part. When combined with the multi-purpose ladder technique, both ladder legs, or at least one ladder leg, can be extended. Then this has two ladder parts, one closer to the joint, one further away from the joint. Ladders have also become known which have several joints.

The ladder parts must be fixed against each other before climbing the ladder so that they neither slip into each other nor swing off accidentally. A hook or similar is typically provided on one ladder part to fix the length. This is supported on a step or rung of the other ladder part. In this way, the extendable ladder leg can be used in the grid dimension of a step or rung in different extension lengths.

Multi-purpose ladders reach their limits when it is necessary to perform work on a roof, typically at a considerable height. Then it would be convenient to be able to work at a distance from the roof. For such work, however, special ladders are needed, namely so-called offset ladders. These have a support leg extending at an angle of, for example, about 110 degrees to the step leg of this ladder, which serves exclusively to support against the wall of the house.

However, roof overhangs are by no means always the same, but typically vary from house to house. Therefore, the support leg is usually designed for a medium roof overhang. Accordingly, if only a ladder with a support leg that is too short is available, there is a risk that the user will use it and lean back to work on the roof at a high height. This not only creates the risk of the user losing balance. Depending on the leaning angle selected, there is even a risk that the ladder, with the user standing on it at a high height, will overbalance away from the wall, causing the user to fall to the ground from a high height, which could even result in fatal injuries.

### SUMMARY

It is an object of the disclosure to provide a ladder that is less prone to accidents and satisfies all possible applications to the greatest possible extent.

This object is achieved by the ladder as described herein.

The ladder has a step leg and a support leg connected to the latter via a joint, wherein the joint is adjustable and the ladder latches automatically with the joint in the angular positions at 0°, between 25° and 45°, between 100° and 120° and at 180°. The support leg is used for variable support of the step leg of the ladder. The joint is adjustable in terms of the pivoting angle between the step leg and the support leg. In particular, the joint can be used to automatically latch the ladder in the angular positions at 0°, 35.5°, 110° and at 180°.

According to the disclosure, it is provided that the support leg of the ladder is adjustable with respect to its length, namely adjustable in a fine grid dimension. This measure allows an exact length adjustment of the support leg, for example, even if the ladder is put up on houses with different roof overhangs. The ladder according to the disclosure forms an offset ladder with adjustable offset.

For safety reasons, to avoid the risk of falling, the user will adjust the support leg in advance to a length at least equal to the-estimated-roof overhang. In this state of adjustment, the user will lean the ladder against the house and take note that the adjustable support leg is of sufficient length. If the user sees that the support leg is too short, the user will adjust the ladder to the desired roof overhang before climbing, i.e. extend the support leg.

Preferably, when putting up the ladder, the support leg is longer than the roof overhang, e.g. by 10 cm to 50 cm. Secondly, it should run essentially horizontally. This is accompanied by a specified leaning angle of the ladder against the house or other building.

The angle adjustability of the joint allows it to be set in the desired manner. For example, if a leaning angle of 20 degrees is desired, the joint is set to an angle of 110 degrees between the step leg and the support leg. This automatically results in a horizontal course of the support leg.

With the double adjustability according to the disclosure, the accident risk of previous ladders can be safely eliminated when handled properly, and a variety of different climbing situations can also be safely covered according to the disclosure.

Furthermore, according to the disclosure, it is preferred that the adjustable ladder leg has two ladder parts which can be adjusted against each other in one go, i.e. completely. These ladder parts are guided along each other and can be moved relative to one another. Each ladder part forms a kind of mini-ladder with fixed stringers, which improves stability. One of these ladder parts has a latching device with a latching element. The other ladder part has a series of recesses or projections.

The recesses or projections are adjacent to each other. The latching element is configured to fit into a recess or to be engaged with a projection. When the latching element engages the recess or engages the projection, the two ladder parts are fixed against each other and form a partial ladder of a certain length. The length depends on the recess in which or on which the latching element engages. However, the recesses or projections are spaced at such a distance that sufficient material remains between them to ensure mounting of the latching element.

The recesses or projections are preferably configured in the stringer or particularly preferably in both stringers of the one ladder part, in a row with a predetermined grid dimension. If the recesses or projections are realized in or on both stringers, two latching elements extend into them, and at the same time into such recesses or projections which are provided at the same height. The mounting on both sides results in a particularly stable and torsional rigid positioning of the ladder leg which comprises the two ladder parts.

According to the disclosure, it is provided that the grid dimension of the recesses or projections is significantly less than half the distance between the steps or rungs, i.e. the treads. The number of recesses or projections between the treads depends to a considerable extent on the type of ladder. A heavy-duty ladder or an industrial ladder will require more material to remain between the recesses or protrusions than a do-it-yourself ladder. For example, the number of recesses or projections between the treads can range from 4 to 40, but can also be less or more.

The latching elements preferably extend essentially horizontally and penetrate the stringers from the inside, i.e. from the area of the center between the stringers. The recesses are preferably configured as openings in the stringers, but may also be blind holes. The projections may be formed in any suitable manner. For example, they may be studs or blocks projecting from the stringer, preferably from its inner wall. Combinations of projections and recesses are also possible according to the disclosure, e.g. corrugations on the stringer or stringers.

In general, any three-dimensional structure that is suitable for the form fit with respect to the latching element can be used as a projection and/or recess. The latching element in question enters the recess and passes at least partially through it, or rests against the projection. Preferably, however, it does not protrude or does not protrude substantially beyond the stringer on the outside thereof.

If the stringer has a hollow profile such as a rectangular profile, it is also possible for the latching element to enter only the inner wall of the stringer and for the recess to be provided only in this. The outer wall is then closed and the latching element is not visible from the outside.

It is particularly preferred if the latching elements are spring-loaded so that they enter recesses or engage with the projections as soon as they are aligned with them. This solution enables the ladder parts to be fixed against each other at all times and not to accidentally slip into each other.

According to the disclosure, the fixing is then released preferably with an actuating device. The actuating device acts on the latching element or elements and disengages them from the recesses. The latching element is withdrawn from the relevant recess so that the ladder parts can be displaced relative to one another. When the actuating device is released, the latching elements are automatically pretensioned in the direction of the recesses. When the ladder parts are then moved against each other, the latching elements engage in the next adjacent recess. This happens automatically, due to the spring pretension of the latching elements, so that incorrect operation is ruled out.

The actuating device can have any suitable design. It is intended to disengage the latching elements. For this purpose, it is possible, for example, to attach to the latching element an angle which extends transversely to its course and which projects upwards or preferably downwards. By actuating the angle against the action of the spring element acting on the latching element, the latching element is retracted and is no longer in engagement with the recess. By suitably designing the angle of the latching device, both latching elements can also be retracted together therefrom. The actuating device then forms a single-handed actuating device, i.e. it can be operated by the user with one hand.

Preferably, the latching elements and the latching device and the actuating device extend at a point where they do not interfere. It is particularly favorable if the actuating device is arranged approximately in the middle between the stringers.

### BRIEF DESCRIPTION OF THE DRAWINGS

The disclosure will now be described with reference to the drawings wherein:

FIG. 1A shows a perspective view of a ladder according to the disclosure in one embodiment, with the adjustable ladder leg extended;

FIG. 1B shows the embodiment according to FIG. 1A, but in the front view;

FIG. 1C shows the embodiment according to FIG. 1A, but in the side view;

FIG. 2A shows the embodiment according to FIG. 1, but with the adjustable ladder leg retracted;

FIG. 2B shows the embodiment according to FIG. 2A, but in the front view;

FIG. 2C shows the embodiment according to FIG. 2A, but in the side view;

FIG. 3 shows the latching device of the ladder according to the disclosure in section in an extended position of the latching elements;

FIG. 4 shows side views of the ladder with different angular positions of the joint;

FIG. 5 shows a perspective view of the ladder with an angular position of the joint of 0°;

FIG. 6 shows a perspective view of the ladder with an angular position of the joint of 35.5°;

FIG. 7 shows a perspective view of the ladder with an angular position of the joint of 110°; and

FIG. 8 shows a perspective view of the ladder with an angular position of the joint of 180°.

### DESCRIPTION OF EXEMPLARY EMBODIMENTS

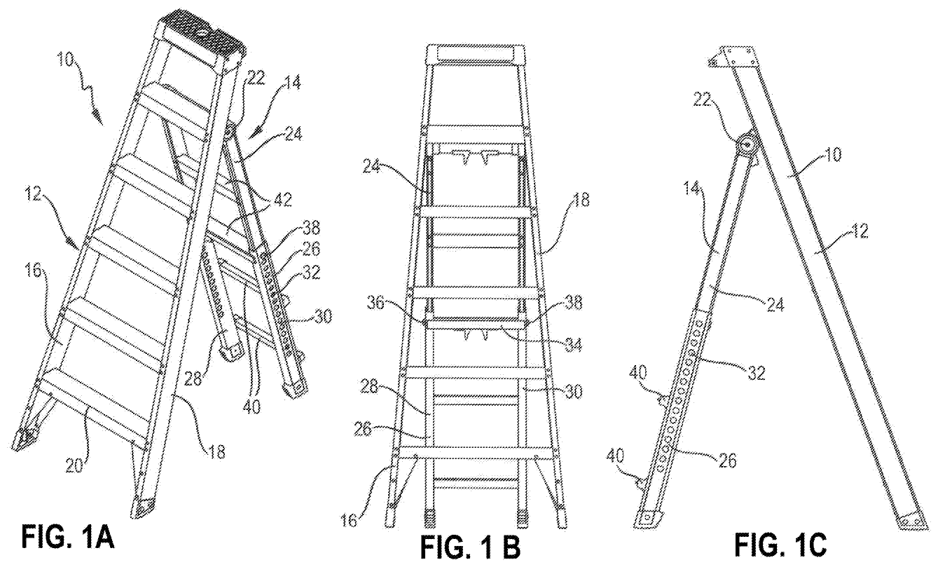

FIG. 1A shows a ladder 10 consisting of two ladder legs, namely a step leg 12 and a support leg 14. The step leg 12 comprises two stringers 16 and 18, between which a plurality of treads 20 extend. In the illustrated exemplary embodiment, the five treads are formed as steps.

The stringers 16 and 18 converge upward, so are more closely adjacent at the top than at the bottom. The two ladder legs 12 and 14 are connected to each other by joints, a joint 22 being evident from FIG. 1A. The support leg 14 consists of a ladder part 24 close to the joint and a ladder part 26 remote from the joint.

The two ladder parts 24 and 26 are slidably mounted to each other. They comprise stringers 28 and 30. The stringers 28 and 30 extend parallel to each other. The stringers 28 and 30 each have a C-shaped cross-section. The two C-shaped cross sections of the ladder parts 24 and 26 overlap each other. In the illustrated exemplary embodiment, the stringers of the ladder part 26 remote from the joint overlap the stringers of the ladder part 24 close to the joint. A kinematic interchange is of course also possible.

In the illustrated exemplary embodiment, the ladder part 26 remote from the joint has a plurality of recesses 32 in its stringers. The recesses 32 each extend in the center leg of the C-shaped profile of the stringers 28 and 30. The recesses 32 extend in a row in a grid dimension. In the illustrated exemplary embodiment, the recesses 32 are configured as circular holes. Their diameter is about one third of the horizontal extension of each of the stringers 28 and 30. The vertical spacing of the recesses 32 from each other is slightly less than the diameter of the holes. The grid dimension of the row of recesses 32 is therefore somewhat less than twice the diameter, in the illustrated exemplary embodiment about 170% of the diameter.

In the illustrated exemplary embodiment, nine recesses 32 are provided between adjacent treads, which are formed here as rungs 40. It is understood that the exact number of recesses between treads can be adapted to the requirements to a large extent. In any case, the number of recesses between adjacent treads is two or more, preferably four or more.

According to the disclosure, a latching device 34 is provided, which can be seen somewhat better from FIG. 1B. The latching device 34 comprises two latching elements 36 and 38. The latching elements 36 and 38 are formed in the manner of tubes or rods. The front ends of the latching elements 36 and 38 can each enter a recess 32. From FIG. 1A, it can be seen that the latching element 38 passes through the uppermost recess 32 and projects outwardly therefrom.

The latching device 34 in detail is described further below.

FIG. 1B shows the ladder 10 in plan or front view. It is clearly seen that the stringers 16 and 18 converge to each other towards the top and diverge towards the bottom. The stringers 28 and 30 extend parallel to each other, so that displacement of the ladder parts 24 and 26 is readily possible with the stringers 28 and 30 sliding along each other. Identical reference signs indicate identical parts here as well as in the further figures and require no additional explanation.

FIG. 1C shows the ladder 10 in side view. In this position, the ladder 10 forms a stepladder. In a manner known per se, the spread angle of the support leg 14 from the step leg 10 is limited. In the illustrated exemplary embodiment, the limitation is realized by the joint 22. It is understood that instead of this, in a manner known per se, a chain or a band can also be provided, which connects the stringers 18 and 30 on the one hand and 16 and 28 on the other hand.

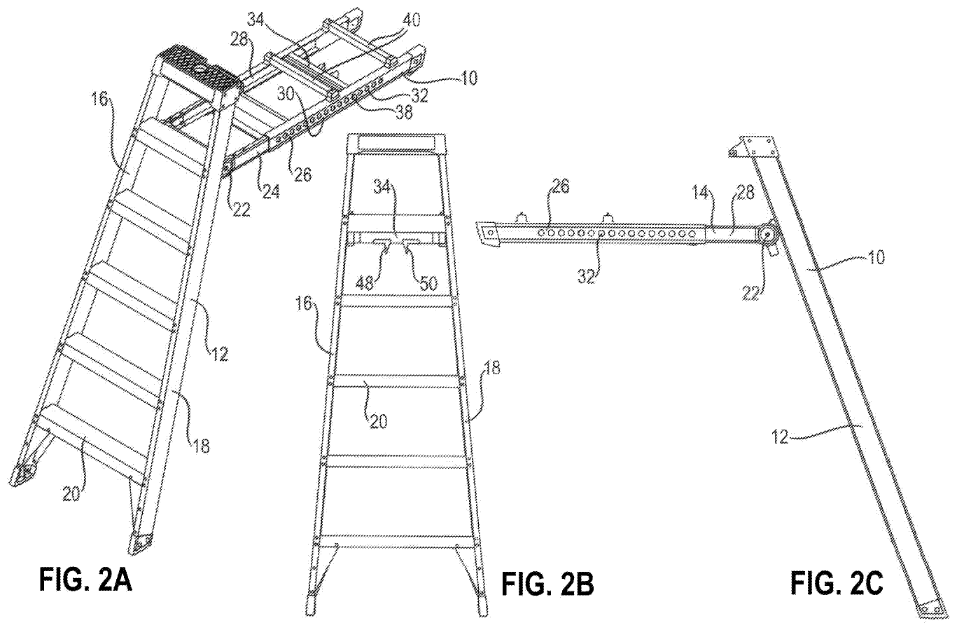

FIGS. 2A, 2B and 2C correspond to FIGS. 1A, 1B and 1C. The difference is that the support leg 14 is retracted in FIG. 2 and extended in FIG. 1. The condition of the ladder 10 according to FIG. 2 is particularly suitable if the ladder 10 is to be used as an offset ladder leaning against a building.

As can be seen in particular from FIG. 2C, the support leg 14 and the step leg 12 then have an angle of about 110 degrees to each other. The angle is adjusted by the joint 22. The joint 22 has a joint latching device for this purpose. When this is actuated, the two legs 12 and 14 can be pivoted freely against each other. When it is released, the joint latching device latches at the current angular position so that the pivoting angle of the legs 12 and 14 to each other is fixed. In this state, the support leg 14 of the ladder 10 is significantly shorter than the step leg 12, respectively.

When leaning against the building, the support leg 14 should be horizontal or substantially horizontal. The preferred leaning angle is between 15 and 25 degrees, so that the joint 22 is preferably set to an angle between 105 degrees and 115 degrees.

According to the disclosure, the multi-purpose ladder is also configured for working on roof overhangs. It then forms an offset ladder. The position of the ladder 10 shown in FIG. 2C is suitable for this purpose. With the support leg 14 fully retracted, it is possible to work on a roof overhang of, for example, 50 cm or 80 cm.

The special feature of the ladder 10 according to the disclosure is the free and fine adjustability of the length of the support leg 14. If the roof overhang is 1 m or 1.20 m, the support leg 14 is extended by 20 cm or 40 cm with the latching device 32 according to the disclosure. When the actuating device 52 is released, the set length of the support leg is fixed. The user then has, as it were automatically, a sufficient working distance or offset from the wall so that the user cannot get into the dangerous backward position. For large roof overhangs, the support leg 14 is fully extended. In this way, it is possible to work safely even on the largest roof overhangs of 2 m that occur in practice. In this respect, the fine adjustment of the length of the support leg 14 according to the disclosure permits exact adjustment to the respective application, for example to the roof overhangs of different sizes on which the ladder according to the disclosure is to be used.

If work is to be carried out on the wall of the building not shown, there are two possibilities. Either the support leg 14 is set to the minimum length, i.e. fully retracted. In this case, the user stands on a tread 20 of the step leg 12 at a distance from the wall, e.g. at a distance of 1 m. This position is useful for certain types of work, for example, when a long-handled tool is to be used to work on a larger area of the wall in one go, for example, with a handle brush or a long-handled hose nozzle of a hose for cleaning the building. In this way, the number of necessary repositioning operations of the ladder can be reduced, which benefits the working speed.

Or the joint is brought to an articulated position in which the support leg 14 and the step leg 12 extend at an angle of 180 degrees to each other. In this articulated position, the multi-purpose ladder according to the disclosure is a leaning ladder.

It is also apparent from FIG. 2A that in this condition of the ladder 10, the latching element 38 extends out of a recess 32 spaced far from the joint 22. In this respect, the position shown corresponds to a fairly far retracted state of the support leg 14 of the ladder 10.

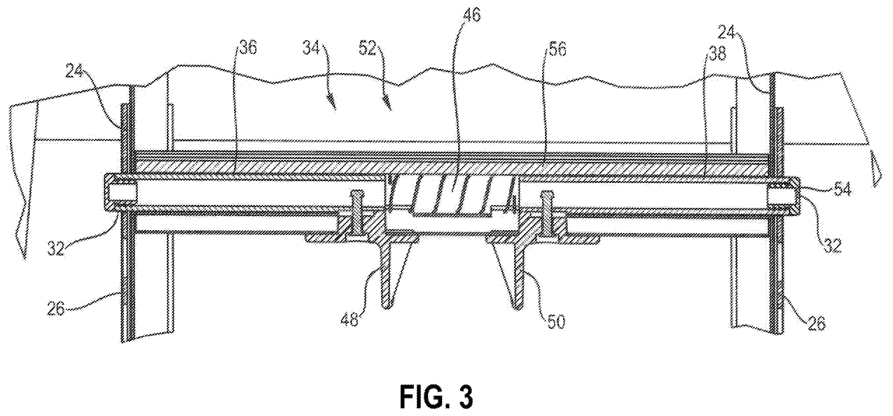

FIG. 3 shows a section through part of the support leg 14 to illustrate the latching device 34. In addition to the latching elements 36 and 38, the latching device 34 also has a spring 46. The spring 46 is designed as a compression spring and pushes the two latching elements 36 and 38 apart.

In the relaxed state of spring 46 shown in FIG. 3, the latching elements 36 and 38 enter recesses 32 in the stringer of the ladder part 26 remote from the joint. Both latching elements 36 and 38 can be moved towards each other against the action of the spring 46. Angles 48 and 50 are used for this purpose, angle 48 being fixedly connected to the latching element 36, and angle 50 being fixedly connected to the latching element 38. The two angles extend away from the joint 22. Their distance from each other is such that they can be readily grasped with one hand, for example between thumb and index finger, and moved toward each other to disengage the latching elements 36 and 38 from their respective recesses and thus unlock the latch. In this respect, the ladder 10 according to the disclosure permits single-handed operation in adjusting the length of the support leg 14.

The latching elements 36 and 38 and the angles 48 and 50 in combination with the spring 46 form an actuating device 52 for the latching device 34. When the angles 48 and 50 are pressed together, the latching elements 36 and 38 are disengaged from the recesses 32. As a result, the ladder part 26 remote from the joint and the ladder part 24 close to the joint can be moved freely relative to one another. When the angles 48 and 50 are released, the two ladder parts can still be moved against each other, but the latching elements 36 and 38 press from the inside against the center legs of the stringers 30 and 28 of the lower ladder part 26.

A small force must be applied for the displacement. As soon as the latching elements 36 and 38 are aligned with the next recess 32, they engage with it and latch there. The ladder 10 has then taken a fixed state in this respect and can be set up in a stable manner.

It can be clearly seen from FIG. 3 that the latching device 34 is guided on the ladder part 24 close to the joint. The recesses 32 are formed in the ladder part 26 remote from the joint and extend, as it were, distally therefrom. The latching elements 36 and 38 are guided in a sleeve 56, which also receives the spring 46.

In the illustrated exemplary embodiment, the latching elements 36 and 38 are designed as tubes. The distal ends of the latching elements 36 and 38 are closed with plugs 54. Instead, they can also be designed as rods.

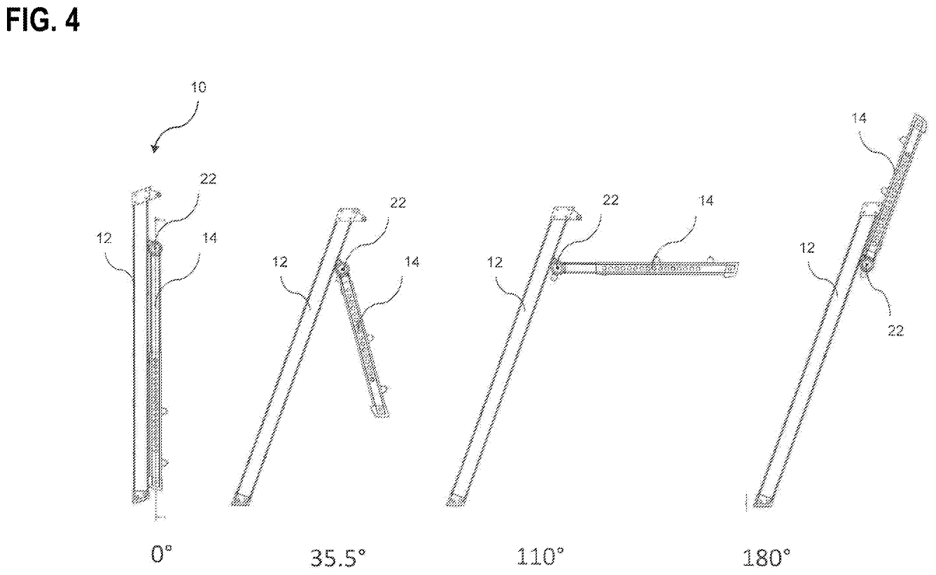

FIG. 4 shows side views of the ladder 10 with different angular positions of the joint 22. In the closed position with an angle of 0°, the ladder 10 can serve as a folded short leaning ladder. In the position with an opening angle of 35.5°, the ladder can serve as a stepladder on level ground. Due to the fine grid adjustment of the support leg 14, in the position with an opening angle of 35.5° the ladder 10 can be used as a stepladder with different height levels of the step leg 12 and support leg 14, e.g. on stairs at an opening angle of 35.5°. In the position with an opening angle of 110°, the ladder 10 can be supported horizontally with the support leg 14, e.g. against a wall. For this purpose, the support leg 14 is extended to a maximum of 1.20 m. This is made possible by the grid adjustment facility on the support leg 14. In the position with an opening angle of 180°, the ladder 10 serves as an unfolded long leaning ladder.

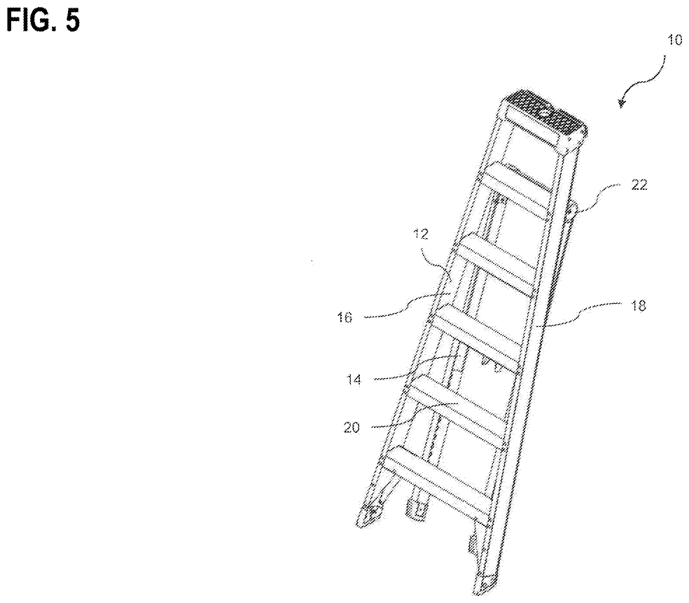

FIG. 5 shows a perspective view of the ladder 10 with an angular position of the joint 22 of 0°. The ladder has two ladder legs, namely a step leg 12 and a support leg 14. Analogous to the above figures, the step leg 12 has two stringers 16 and 18 between which a plurality of treads 20 extend. The stringers 16 and 18 converge upwardly, so are more closely adjacent at the top than at the bottom. The two ladder legs 12 and 14 are connected to each other by joints 22. In the closed position, with the angle of the joint 22 at 0°, the ladder 10 can serve as a folded short leaning ladder.

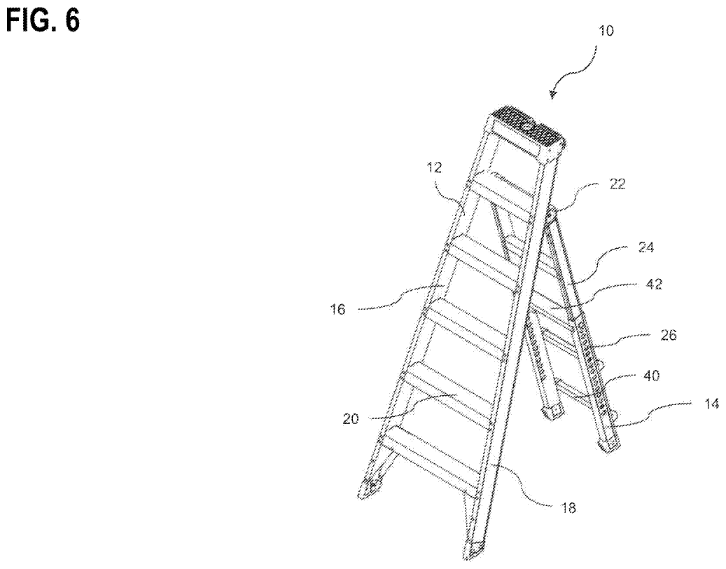

FIG. 6 shows a further perspective view of the ladder 10 analogous to FIG. 5, but now with an angular position of the joint of 35.5°. The support leg 14 consists of a ladder part 24 close to the joint and a ladder part 26 remote from the joint, which are mounted on each other for sliding movement. The ladder part 26 remote from the joint has rungs 40 and the ladder part 24 close to the joint has steps 42 as treads.

In the position with an opening angle of 35.5°, the ladder serves as a stepladder on level or even uneven ground. Since the support leg 14 consists of two slidingly mounted ladder parts 24 and 26 with fine grid adjustment, the length of the support leg 14 can be adapted to the ground conditions. For example, the support leg 14 can be extended to the same length as the step leg 12 so that the ladder 10 can be used as a stepladder on level ground. However, the support leg may also be retracted so that the step leg 12 and support leg 14 each have different height levels, allowing the ladder 10 to be used as a stepladder on uneven ground, such as stairs. Depending on how far the support leg 14 is pushed in, the stepladder can also be adapted to the rise of the stairs.

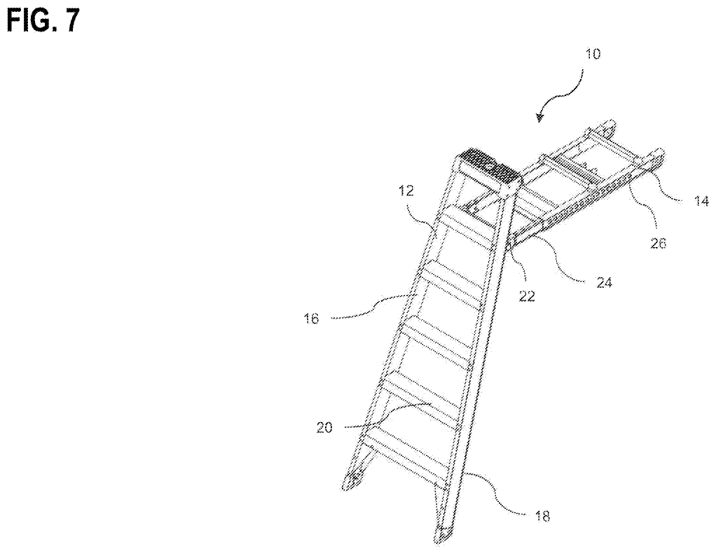

FIG. 7 shows another perspective view of the ladder 10 analogous to FIG. 5 or 6, but with an angular position of the joint of 110°. In the position with an opening angle of 110°, the ladder 10 can be supported horizontally with the support leg 14, e.g. against a wall. For this purpose, the two slidingly mounted ladder parts 24 and 26 of the support leg 14 are retracted to the maximum extent. The support leg 14 then has a maximum length of 1.20 m, for example. Due to the maximum retraction of the two ladder parts 24 and 26, further retraction is not possible, so that the ladder 10 can be safely leaned against the wall. The danger of the two ladder parts 24 and 26 pushing in further during this possible use due to the force exerted on the support leg 14, and possibly even leading to a hazard to the user, is thus prevented in a simple and reliable manner.

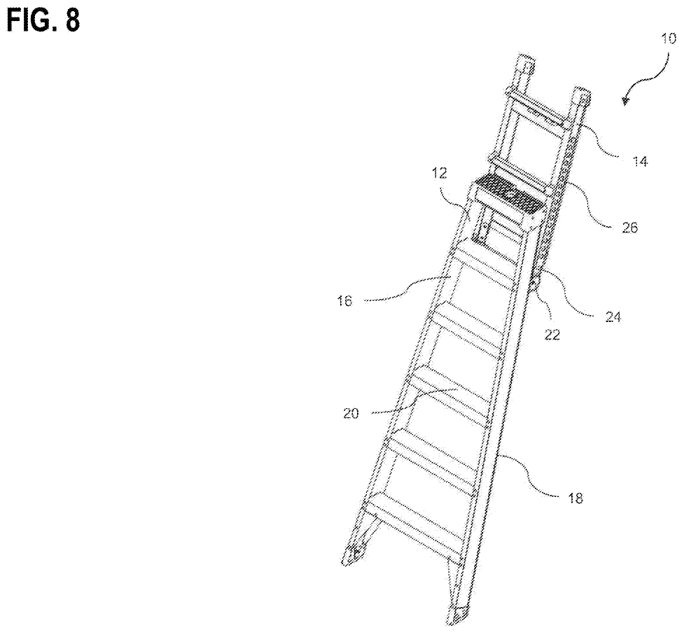

FIG. 8 shows another perspective view of the ladder 10 analogous to FIGS. 5 to 7, but with an angular position of the joint of 180°. In the position with an opening angle of 180°, the ladder 10 serves as an unfolded long leaning ladder. The length of the ladder 10 as an unfolded long leaning ladder can be adapted to the respective conditions with the two slidingly mounted ladder parts 24 and 26 of the support leg 14.

All of the features explained and shown in connection with individual embodiments of the disclosure may be provided in different combinations in the subject matter of the disclosure to simultaneously realize their beneficial effects.

The scope of protection of the present disclosure is given by the claims and is not limited by the features explained in the description or shown in the figures.

It is understood that the foregoing description is that of the exemplary embodiments of the disclosure and that various changes and modifications may be made thereto without departing from the spirit and scope of the disclosure as defined in the appended claims.

What is claimed is:

1. A ladder, comprising:
a step leg; and
a support leg connected to the step leg via a joint,
wherein the joint is adjustable, and
wherein the ladder latches automatically with the joint in the angular positions at 0°, between 25° and 45°, between 100° and 120° and at 180°.

2. The ladder according to claim 1, wherein the support leg is adjustable with regard to its length, in particular with a latching device comprising latching elements, and in a predetermined grid dimension.

3. The ladder according to claim 1, wherein the support leg has a ladder part close to the joint and a ladder part remote from the joint,
wherein one ladder part of the support leg has a row of recesses or projections on at least one stringer, in particular on each stringer, which recesses or projections are spaced apart from one another by less than half the distance of the treads, and
wherein a latching device on the other ladder part has a latching element which can be introduced into a recess on the one ladder part or can be brought into engagement with a projection on the one ladder part.

4. The ladder according to claim 1, wherein the latching device comprises two latching elements, and
wherein each latching element acts on one of the two stringers of the one ladder part.

5. The ladder according to claim 1, wherein the latching device acts jointly on both latching elements and on both stringers and both latching elements can be actuated jointly with the latching device, and in particular is configured to be suitable for single-handed actuation, and/or
wherein both latching elements of the latching device are guided in or along a common guide, and/or
wherein both latching elements of the latching device are mounted in an area between the stringers and move away from one another during latching.

6. The ladder according to claim 1, wherein the latching elements are preloaded towards the stringers by one spring or several springs and/or
wherein at least one spring of the latching device presses both latching elements away from each other, and
wherein in particular a common spring is provided for the latching elements which presses the latching elements towards the stringers.

7. The ladder according to claim 1, wherein the recesses or projections are spaced apart from one another at a predetermined recess grid dimension or projection grid dimension, which grid dimension is between 1 cm and 10 cm, in particular between 2 cm and 4 cm and particularly preferably between 2 cm and 4 cm.

8. The ladder according to claim 1, wherein the one ladder part is the ladder part remote from the joint and the other ladder part is the ladder part close to the joint.

9. The ladder according to claim 1, wherein the support leg can be pivoted with the joint into a position spread by more than 90 degrees relative to the step leg, in particular into a horizontal position when the ladder is leant.

10. The ladder according to claim 1, wherein the joint has a joint latching device known per se, with which the pivoting angle of the joint can be adjusted and fixed and/or
wherein the ladder leg forming a step leg has stringers and treads (steps or rungs) between the stringers, and the support leg of the ladder has stringers, connecting elements or treads (steps or rungs).

11. The ladder according to claim 1, wherein the recesses or projections in the one ladder part are configured in the inner wall of the stringer facing the treads or connecting elements, or, in the presence of an outer wall facing away from the treads or connecting elements, also in the outer wall, or exclusively in the inner wall.

12. The ladder according to claim 1, wherein the latching elements are in the form of rods or tubes, and/or
wherein the recesses or projections have a diameter 2% to 50% larger than the latching elements, and/or
wherein the latching elements have lead-in chamfers, in particular lead-in chamfers pointing toward the joint, and/or
wherein the latching elements are guided at their stringer-side ends in guide elements whose play relative to the latching elements is less than the play of the latching elements in the recesses.

13. The ladder according to claim 1, wherein for both latching elements an actuating device, in particular a single-handed actuating device, is provided which acts jointly on these two latching elements and with which the latching elements can be disengaged from the recesses or projections in the one ladder part, and/or
wherein the latching elements can be moved towards one another with an actuating device, and in particular can be disengaged from the recesses or the projections with the actuating device.

14. The ladder according to claim 1, wherein an actuating device of the latching device has an angle each acting on a latching element, each of which angles is closer to the center between the stringers than to the stringers.

15. The ladder according to claim 14, wherein the actuating device is arranged below a tread or connecting element and closer thereto than to the next tread or connecting element further remote from the joint.
